(19) United States
(12) Patent Application Publication
(10) Pub. No.: US 2019/0315964 A1
(43) Pub. Date: Oct. 17, 2019

(54) BINDER FOR INJECTION MOULDING COMPOSITIONS

(71) Applicant: Comadur S.A., Le Locle (CH)

(72) Inventor: Pablo RODRIGUEZ, Neuchatel (CH)

(73) Assignee: Comadur S.A., Le Locle (CH)

(21) Appl. No.: 16/462,112

(22) PCT Filed: Oct. 17, 2017
(86) PCT No.: PCT/EP2017/076486

§ 371 Date: May 17, 2019

(30) Foreign Application Priority Data
Dec. 8, 2016 (EP) 16203041.5

(51) Int. Cl. C08L 91/06; B22F 1/00

(52) U.S. Cl. CPC C08L 91/06; B22F 1/0059

(57) ABSTRACT

Binder for injection moulding composition including:
from 45 to 50 volume percent of a polymeric base,
at least 34 volume percent of a mixture of waxes or a mixture of wax and palm oil,
and from 11 to 16 volume percent of a surfactant,
wherein the polymeric base contains ethylene and methacrylic or acrylic acid copolymers, or ethylene copolymers comprising a maleic anhydride or a mixture of such copolymers, in addition to polyethylene, polypropylene and an acrylic resin, the respective quantities of the binder components being such that added together, they do not exceed 100 volume percent.

### FIELD OF THE INVENTION

The invention concerns a binder composition for injection moulding and an injection moulding composition (feedstock) intended for the manufacture of shaped metal parts.

### BACKGROUND OF THE INVENTION

In the fabrication of hard materials for jewellery and the watch industry, or for technical applications such as medical equipment, electronics, telephony, tools, machine cutting inserts and the consumer goods industry, powder metallurgy techniques are implemented. The synthesized inorganic material obtained will be referred to as ‘metal’ here, regardless of the nature of the metal or metal alloy. The basic raw materials are different in nature, generally speaking, and include at least on the one hand metal powder, and on the other hand organic binders, such as resins or plastic materials or suchlike, which can be injection moulded and provide good mechanical strength of the component made with the mixture of all the raw materials. Other additives may be included in the mixture. These raw materials may also be of different textures: solid, powder, liquid or paste. The structure of the mixture may also change during its creation, in particular but not exclusively, when complementary components of a resin undergo a polymerization reaction.

The overall fabrication process of a metal component by powder metallurgy includes at least the following steps:
preparing raw materials;
mixing raw materials, or/and pre-mixing two at a time (or more) if required;
homogenization kneading;
granulating;
pressing, notably in a pressing chamber, a quantity of powder or feedstock pellets obtained from the homogenizing and granulating steps, to create a blank or ‘green part’. This pressing operation can be performed by injection moulding, under pressure, notably in a screw injector including means for heating this quantity of powder or feedstock pellets obtained from the homogenizing and granulating;
debinding in an oven for combustion and/or dissolution of certain constituents of the mixture;
heat treating the green part after debinding for the sintering process that gives the finished component its final coherency. This heat treatment causes dimensional shrinkage, which makes it possible to obtain a component with the final dimensions,
surface finishing treatment of the component.

It is a particular object of the invention to propose an optimised binder for injection moulding compositions that facilitates power metallurgy mixing to obtain metals, in order to produce metal parts having complex shapes and highly reproducible quality, with a controlled shrinkage coefficient.

There are already known thermoplastic materials (feedstocks) for the manufacture of moulded metal parts that contain a sinterable metal powder and an organic polymeric binder, the latter being essentially formed of a mixture of polyoxymethylene and copolymers of polyoxymethylene and polyoxolane, such materials (feedstocks) are for example sold by BASF under the trade name Catamold®.

These feedstocks have, however, revealed numerous drawbacks, such as, for example, insufficient fluidity for injection moulding, thereby limiting the complexity of the parts that can be made by this means and sometimes requiring expensive mechanical re-machining operations; and problems of mechanical strength of moulded parts which exhibit cracks and lamination, especially when the shape of the parts is critical. They are also responsible for environmental problems caused by the necessity of using aggressive products such as nitric acid, especially to remove the organic phase in the debinding step.

There is also known from CH Patent No. 707572 a binder for injection moulding compositions including a polymeric base, a mixture of waxes and/or palm oil and a surfactant. With such a binder composition, debinding is performed in two distinct, successive steps, namely a first partial debinding step using a solvent, followed by a second thermal debinding step. During the first debinding step, the binder components that are soluble in the solvent, namely the mixture of waxes and the surfactant and acrylic resins, are removed. In practice, this operation is carried out in batches in an oven containing the green parts and the appropriate solvents. The batch is then placed in a batch furnace in which the binder components that were not dissolved in the chemical debinding step are removed, generally by heating the green parts to a temperature of around 600° C. Once debinding has occurred, i.e. the organic elements have been removed, and only at this moment, the parts are sintered in the same furnace by heating to a temperature of around 1200° C.

This batch manufacturing technique gives good results but handling successive batches means it is not possible to achieve satisfactory production rates with existing facilities.

Consequently, it is an object of the present invention to provide a binder for injection moulding compositions which obviates the aforementioned drawbacks, and more particularly which intends to improve the homogeneity and fluidity of the feedstock in order to manufacture metal parts with more complex shapes, to reduce the production cycle time, to limit or obviate the need for mechanical finishing processes, and finally which removes the need to use environmentally damaging products to remove the organic binder, by replacing the latter with non-polluting solvents that can be removed by a simple heat treatment.

### SUMMARY OF THE INVENTION

The invention thus concerns a binder for an injection moulding composition including:
from 45 to 50 volume percent of a polymeric base,
at least 34 volume percent of a mixture of waxes or a mixture of wax and palm oil,
and from 11 to 16 volume percent of a surfactant,

wherein the polymeric base contains copolymers of ethylene and of methacrylic or acrylic acid, or ethylene copolymers containing a maleic anhydride or a mixture of such copolymers, in addition to polyethylene, polypropylene and an acrylic resin, the respective quantities of the binder components being such that, added together, they do not exceed 100 volume percent and are preferably equal to 100 volume percent.

As a result of these features, the thermal debinding step can be shortened and, for example, a conveyor belt furnace can be used and thus production rates can be optimised while ensuring that debinding is completely finished before the sintering operation. Using facilities of the conveyor belt furnace type thus makes it possible to continuously combine the thermal debinding and sintering step in the same facility and thereby increase the production rate of the parts and at the same time reduce production costs. Moreover, this binder composition has a viscosity that allows injection moulding of flawless complex shaped parts.

Preferably, the binder of the invention includes 4 to 5 volume percent of one of said copolymers or of their mixtures, between 25 and 30 volume percent of polyethylene, 3 to 5 volume percent of polypropylene and 8 to 10 volume percent of acrylic resin.

Preferably, the copolymer of ethylene and methacrylic or acrylic acid contains 3 to 10 wt. % of methacrylic or acrylic comonomer, and the copolymer of ethylene and anhydride is a statistical (random) copolymer of ethylene and maleic anhydride with a melting point of 100 to 110° C. or a copolymer of HD polyethylene and a modified anhydride with a melting point of 130 to 134° C.

Preferably, the acrylic resin has a molecular weight of between 50000 and 220000 and an inherent viscosity of between 0.21 and 0.83 and is chosen from the group including isobutyl methacrylate, methyl methacrylate, ethyl methacrylate and N-butyle methacrylate polymers, and copolymers of isobutyl methacrylate and N-butyle methacrylate and methyl methacrylate or a mixture of these polymers and/or copolymers. ‘Inherent viscosity’ means the viscosity of a solution containing 0.25 g of polymer in 50 ml of methylene chloride measured at 20° C. with a size 50 Cannon-Fenske viscometer.

Advantageously, the wax mixture includes a Carnauba wax and a paraffin wax, or the wax mixture includes a Carnauba wax and a palm oil.

According to another preferred feature, the surfactant is an N,N′-ethylene bis-stearamide or a mixture of stearic and palmitic acids (stearin), or a mixture of these elements.

According to an advantageous feature, the surfactant and the acrylic resins are soluble in isopropyl alcohol and/or turpentine.

The invention also concerns an injection moulding composition (feedstock) intended for the manufacture of shaped metal parts including 70 to 80 volume percent of a metal powder and 20 to 30 volume percent of binder including:
from 45 to 50 volume percent of a polymeric base,
at least 35 volume percent of a mixture of waxes or a mixture of wax and palm oil,
and from 11 to 16 volume percent of a surfactant,

wherein the polymeric base contains copolymers of ethylene and of methacrylic or acrylic acid, or ethylene copolymers containing a maleic anhydride or a mixture of such copolymers, in addition to polyethylene, polypropylene and an acrylic resin, the respective quantities of the binder components being such that, added together, they do not exceed 100 volume percent and are preferably equal to 100 volume percent.

According to a particular feature, the metal powder of the injection moulding composition can be chosen from the group including a tungsten metal powder, a stainless steel powder, a titanium metal powder, a noble metal powder, such as gold, platinum, silver, palladium, rhodium and ruthenium, or a mixture of these metal powders.

### DETAILED DESCRIPTION OF A PREFERRED EMBODIMENT OF THE INVENTION

The present invention will now be illustrated in more detail by the following non-limiting example.

The polymeric part of the binder is mixed with a stainless steel powder (typically a 316L steel powder) at a temperature of around 150° C. to create a premix. The waxes and surfactant are added to this premix, and the temperature is increased again to around 180° C. to form a kind of homogeneous paste. This paste is then simultaneously ground and cooled to ambient temperature to form a powder. This powder is then fed into a calender which cuts and granulates the premix. The product of this last step is kept to form feedstock for use in the manufacture of a shaped part by injection moulding in accordance with a known technique.

In this example, more specifically, 46.5 kg of (316L) stainless steel metal powder (78 volume percent) and 3.5 kg of binder (approx. 22 volume percent) were used having the following volume composition:
28% of HD polyethylene
4% of polypropylene
4.5% of copolymer of ethylene and methacrylic acid (with 6.5 wt. % of methacrylic acid, for example a type such as “Nucrel™” by DuPont)
8.5% of an isobutyl methacrylate polymer resin having a molecular weight of 195,000 (for example a type such as ‘Elvacite™ 2045’ by Lucite International)
1% of an n-butyl and isobutyl methacrylate polymer resin having a molecular weight of 165,000 (for example a type such as ‘Elvacite™ 2046’ by Lucite International)
9% of Carnauba wax
31% of a paraffin wax (for example a type such as ‘Carisma 56T™’ by Alpha Wax BV)
14% of N, N′ Ethylene-bis(stearamide)

1. A binder composition, comprising:
from 45 to 50 volume percent of a polymeric base,
at least 34 volume percent of a mixture of waxes or a mixture of at least one wax and palm oil, and
from 11 to 16 volume percent of a surfactant,
wherein the polymeric base comprises ethylene and methacrylic or acrylic acid copolymers, or ethylene copolymers comprising a maleic anhydride or a mixture of said copolymers, in addition to polyethylene, polypropylene and an acrylic resin, respective quantities of the binder components being such that added together, a total amount of the binder components do not exceed 100 volume percent.

2. The binder composition of claim 1, including comprising:
4 to 5 volume percent of one of said copolymers or of a mixture of said copolymers,
between 25 and 30 volume percent of polyethylene,
3 to 5 volume percent of polypropylene, and
8 to 10 volume percent of acrylic resin.

3. The binder composition of claim 1, wherein
the copolymer of ethylene and methacrylic or acrylic acid, if present, comprises 3 to 10 wt. % of methacrylic or acrylic comonomer, and
the copolymer of ethylene and anhydride, if present, is a statistical (random) copolymer of ethylene and maleic anhydride with a melting point of 100 to 110° C. or a copolymer of HD polyethylene and a modified anhydride with a melting point of 130 to 134° C.

4. The binder composition of claim 1, wherein
the acrylic resin has a molecular weight of between 50000 and 220000 and an inherent viscosity of between 0.21 and 0.83 and
the acrylic resin is a polymer and/or copolymer, which is at least one selected chosen from the group consisting of isobutyl methacrylate, methyl methacrylate, ethyl methacrylate and N-butyl methacrylate polymers, and copolymers of isobutyl methacrylate and N-butyl methacrylate and methyl methacrylate.

5. The binder composition of claim 1, wherein the wax mixture comprises a Carnauba wax and a paraffin wax, or the wax mixture comprises a Carnauba wax and a palm oil.

6. The binder composition of claim 1, wherein the surfactant is an N,N′-ethylene bis(stearamide) or a mixture of a stearic acid and a palmitic acid, or a mixture an N,N′-ethylene bis(stearamide), a stearic acid and a palmitic acid.

7. The binder composition of claim 1, wherein the surfactant and the acrylic resin are soluble in isopropyl alcohol and/or turpentine.

8. An injection moulding composition, comprising:
70 to 80 volume percent of a metal powder and
20 to 30 volume percent of a binder composition
wherein the binder composition comprises:
from 45 to 50 volume percent of a polymeric base,
at least 34 volume percent of a mixture of waxes or a mixture of at least one wax and palm oil,
and from 11 to 16 volume percent of a surfactant,
wherein the polymeric base comprises ethylene and methacrylic or acrylic acid copolymers, or ethylene copolymers comprising a maleic anhydride or a mixture of said copolymers, in addition to polyethylene, polypropylene and an acrylic resin, respective quantities of the binder components being such that added together, a total amount of the component do not exceed 100 volume percent.

9. The injection moulding composition according to claim 8, wherein the metal powder is at least one selected from the group consisting of a tungsten metal powder, a stainless steel powder, a titanium metal powder, and a noble metal powder chosen from the group consisting of gold, platinum, silver, palladium, rhodium and ruthenium.
